(19) United States
(12) Patent Application Publication
(10) Pub. No.: US 2005/0075075 A1
(43) Pub. Date: Apr. 7, 2005

(54) Method and system for determining a network management scalability threshold of a network manager with respect to a network

(76) Inventors: Gabriel Wechter, Fort Collins, CO (US); Eric Pulsipher, Fort Collins, CO (US); Max C. Knees, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,862

(22) Filed: Sep. 23, 2003

(51) Int. Cl. H04B 17/00

(52) U.S. Cl. 455/67.11

(57) ABSTRACT

A method of determining a network management scalability threshold of a network manager with respect to a network, includes gathering information about the network, gathering information about the network manager, and determining a maximum size threshold of a zone in the network based on the gathered network information and the gathered network manager software program information. A system for determining a network management scalability threshold of a network manager with respect to a network includes a mechanism for gathering information about the network, a mechanism for gathering information about the network manager, and a mechanism for determining a maximum size threshold of a zone in the network based on the gathered network information and the gathered network manager software program information.

Related U.S. application Ser. No. ______ bearing Attorney Docket number (032842-148) and identification number (200311662), entitled “Method and System for Managing a Network of Nodes”, having as inventors Gabriel Wechter, Eric Pulsipher and Max Knees, filed in the U.S. Patent and Trademark Office on the same date as this application, is hereby incorporated by reference.

### BACKGROUND

In known network management solutions, when a system running network management software is given an environment or portion of an environment to discover and manage, and processing the associated data would exceed the capabilities and resources of the system, the software and system will fail to scale to that environment and resources of the system become exhausted. In these solutions, the management software can be given only as much of the environment as it can handle at any one time, otherwise it will choke or fail.

Thus known solutions either limited their scalability by supporting only a limited network size that was known to be well within the bounds of what an average system running the network management software could handle, or allowed a large network to be processed in batches. However, the known solutions had no way to determine if each batch of data was too much for the system running the management software to handle, and no way to adjust their operation to the environment in which they were operating. Systems with meager resources would fail by exhausting the resources, and systems with ample resources were not able to use the resources to their full potential. A hard scalability limitation also fails to account for the complexity of a network environment that the management software is working to monitor and/or manage.

### SUMMARY

A method of determining a network management scalability threshold of a network manager with respect to a network, includes gathering information about the network, gathering information about the network manager, and determining a maximum size threshold of a zone in the network based on the gathered network information and the gathered network manager information. A machine readable medium can include software or a computer program or programs for causing a computing device to perform the exemplary method.

A system for determining a network management scalability threshold of a network manager with respect to a network includes a mechanism or means for gathering information about the network, gathering information about the network manager, and determining a maximum size threshold of a zone in the network based on the gathered network information and the gathered network manager information, and includes a mechanism or mechanism for connecting the network manager to the network.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary method of determining a network management scalability threshold of a network manager with respect to a network, in accordance with an exemplary embodiment.

FIG. 2 shows a system block diagram in accordance with an exemplary embodiment.

### DETAILED DESCRIPTION

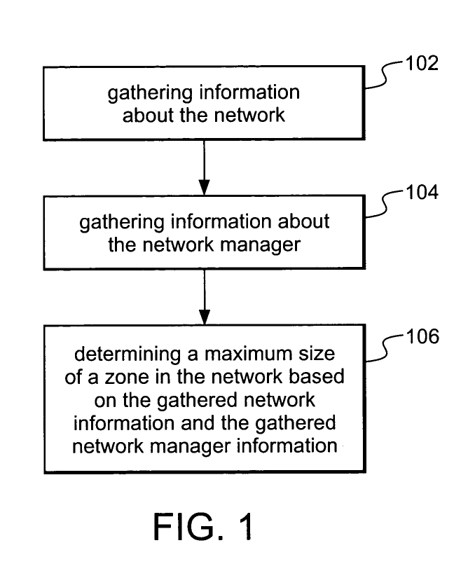

FIG. 1 shows an exemplary method of determining a network management scalability threshold of a network manager with respect to a network.

As shown in FIG. 1, in a first block 102 gathering information about the network is performed. The information about the network can include a number of nodes in the network, and/or a density of connections between nodes in the network, and/or a configuration of network, and/or types of nodes in the network. For example, the gathering of information about the network can include analyzing the network to determine the number of nodes and interfaces that are managed and able to be queried. The information gathering can also include analyzing the network to determine its complexity such as the density or number of connections between devices in the network, determine the type of devices in the network, and determine the network's configuration.

In a next block 104, gathering information about the network manager is performed. The information about the network manager can include, for example, an amount of memory available to the network manager. For example, the gathering of information about the network manager can include determining the characteristics of the system and platform on which the network manager software is running, for example the operating system. This operation can also include determining what system resources need to be analyzed, based on features or version of the operating system and other characteristics. The gathering of information about the network manager can also include determining resources of the system and/or platform on which the network manager software is running, for example an amount of system memory and a maximum amount of memory allocated for storing data.

In a next block 106, determining a maximum size threshold of a zone in the network based on the gathered network information and the gathered network manager software program information is performed. The maximum size threshold of the zone can be expressed as a maximum number of nodes and/or a maximum amount of data, that the network manager can handle discovering simultaneously.

The exemplary method shown in FIG. 1 can be implemented in the network manager. In an exemplary embodiment, the network manager can refuse to discover, manage or process a zone whose size exceeds the determined maximum size threshold. Alternatively, the exemplary method of FIG. 1 can be implemented using resources of the network, or can be implemented using software and hardware resources operating independently of the network and the network manager, and can provide advisory information to the network manager and/or control or direct the network manager, for example by alerting the network manager that a zone has a size exceeding the maximum size threshold, or by directing the network manager not to discover, manage or process a zone having a size exceeding the maximum size threshold.

In an exemplary embodiment, the network on which the method is applied includes specific zone candidates or subsets of the network, where a zone candidate includes specific nodes and their corresponding interfaces. The method shown in FIG. 1 can be applied iteratively, first on a network to determine a first threshold number of nodes, and then on a portion (e.g., a zone candidate) of the network that is selected based on the first threshold number of nodes, to verify that the actual number of nodes, density, configuration etc. of the zone candidate is within or less than a maximum threshold or number of nodes that the network manager (e.g., given its system resources) can handle given the conditions (number of nodes, density, configuration, etc.) inside the zone candidate. If the demands of the zone candidate exceed or fall significantly below the abilities of the network manager then the zone candidate can be refined to form a new zone candidate or another zone candidate can be selected as the new zone candidate, and the method can be applied to the new zone candidate. For example, the new zone candidate is refined or selected to respect the constraints or abilities of the network manager. This process can be iteratively continued, for example until a zone candidate within the capabilities of the network manager is found.

In an exemplary embodiment, a user can test configured zones or zone candidates for a variety of conditions that may produce warnings, for example by activating a “Test Zones” button in a graphical user interface of the network manager. One of these checks can involve comparing the size of the set of network nodes that is described by a configured zone specification against a maximum zone size, as determined by a mechanism (for example in accordance with the method shown in FIG. 1), and warn the user if there is a violation, so that the zone configuration can be changed to respect the maximum zone size and hence prevent failure due to exhaustion of system resources.

The threshold determined in the block 106 can be used to influence a software configuration and a behavior of the network manager, so as to prevent the system or software forming the network manager from failing, by proceeding with analysis of the network data in portion sizes that respect this threshold. For example, if the total number of nodes needing to be analyzed is 2000, and the threshold is determined to be 1000, the network manager can proceed with discovering the entire network by discovering one portion at a time, each with 1000 or fewer nodes.

For example, consider a situation involving two networks A, B. Network A is managed by a certain type of computer, for example a workstation X that has 4 Gigabytes of system memory available for use and running network manager software. Network B is managed by the same type of computer, for example a different workstation Y running the same network manager software but with only 1 Gigabyte of system memory. Now assume that networks A, B are identical, and are found to be somewhat complex, or as complex as an “average” corporate network of a medium-sized business. For example, they include a number of complicated network devices such as switches, and many switches have 30 or so interfaces, with connections running to and from other switches in that network. Assume they have 2000 devices. If one were to draw a conceptual picture of the network it would look like a dense spider web. This network manager would account for the factors mentioned herein and would determine, for example, that the software running on the more powerful station X could handle discovering 1000 nodes in this particular network at one time using available system resources. Hence, the discovery would proceed with discovering the network in two batches, each of which is no greater than 1000 nodes. The network manager would also determine, for example, that the less powerful station Y could handle discovering 400 nodes at a time. Hence, discovery using the network manager implemented on the station Y would proceed in five batches, each with 400 nodes.

By way of further example, now assume that instead of Networks A and B being identical, Network A is much more complex than network B. For example, assume that instead of the description of network B above, that network B is fairly simple, with only a few complex devices, and devices that do not have many connections to many other devices. Conceptually, it may look like a tree with few branches, and a few simple connections between branches. Each of the networks A, B still contains 2000 devices or nodes. In this case, it may be determined, for example, that the more powerful station X can handle discovering/managing 1000 nodes at a time, but that the less powerful station Y could also handle 1000 nodes at a time, since the data associated with network B is less complex.

Exemplary pseudo-code for size threshold calculations of the network manager can be implemented in the following way:

```
- Set a value for the smallest max, max_per_zone_min (say 150).
// This should be based upon the minimum recommended system
specifications, and is used as the default in case the calculation fails.
- max_per_zone = 1;
// First, analyze the system the software is deployed on.
// Determine the amount of resources (memory) available on this system.
- Determine the Operating System (OS) (Ex. HPUX, Windows, Solaris).
- Dependent upon the OS, interface with the OS in the manner required to
determine the physical memory on the system.
- Dependent upon the OS, determine other factors that affect memory
available for the program (For example, if HPUX is the detected OS, use a
command like kmtune to determine the maxdsiz kernel parameter value.)
- Parse the output of the command(s) above to determine memory
value(s) and convert from the represented base to base−10.
- Parse units of measure and use them to standardize by converting
value(s) to megabytes (MB).
- Dependent upon OS, choose the strictest measure of memory available.
(For example, for HPUX, memory_to_use = min(maxdsiz,
physical_memory).)
If (memory determination failed) {
    Use the minimum recommended system specifications (say, 512 MB)
}
memory = final result of memory calculation.
// Now analyze characteristics of the network environment which the
software is deployed to manage.
// (Or, more generally, gather characteristics of the objects representing
data that the software will need to process.)
// This will allow us to characterize how the processing of this
environment will use resources (and how much) by analyzing its size,
configuration, complexity, and relationships.
- net_nodes = Query the topology database (or network) for all node
objects.
- Throw out those objects from net_nodes that do not have a valid name,
status, or address for SNMP communication.
- Count the resulting total number of nodes.
- Apply a set of heuristics (based upon empirical control data of number
of nodes discovered
vs. memory use) to calculate a conservative basis for the max number of
nodes per zone (based only upon info about the system resources at this
point).
if (memory < 512 MB) {
    max_per_zone = max_per_zone_min;
} else if (memory < 1024 MB) {
    max_per_zone = 200
} else if (memory < 2048 MB) {
    max_per_zone = 250
} else if (memory > = 2048 MB) {
    max_per_zone = 350
}
if (max_per_zone < max_per_zone_min) {
    max_per_zone = max_per_zone_min;
}
// Now refine the max_per_zone number, or the maximum size threshold
of a zone in the network, based upon the actual environment.
foreach (node in net_nodes) {
    - Determine what type of networking device this node is (switch,
router, simple end node).
    - increment the count that tracks the occurrence of this type of device.
    - If (device is a switch) {
        Make query to the device's forwarding table info to estimate
the number or complexity of its connections to other devices, including
other switches.
        increment count_of_connections.
    }
    foreach (interface on node) {
        increment iF_count;
    }
}
// Now, characterize network complexity and map that to the max_per_{—}
zone scalability threshold value.
// Comparison is done against a standard base set of data representing a
control environment from which the basis numbers above were derived.
(ex. basis_sw_to_other_ratio is the ratio found to exist in the control
environments upon which the basis node vs memory numbers were
derived).
// Note: to micro-optimize further, the adjustment criteria below can be
more granular.
- Find ratio of switches to all other devices or nodes, sw_to_other_ratio,
based on our tallies above.
if (sw_to_other_ratio > = 2 * basis_sw_to_other_ratio) {
    // Network is very flat, with large subnets and few routers between
them.
    // A higher number of VLAN and other L2 relationships between the
devices is likely.
// Revise the zone size threshold number down to account for the
increased number of objects (and memory) required to represent these.
    max_per_zone = .75 * max_per_zone;
} else if (sw_to_other_ratio < .5 * basis_sw_to_other_ratio) {
    max_per_zone = 1.25 * max_per_zone;
} // else, dont adjust it.
- Find the ratio of connections to devices or nodes, conns_ratio, based on
tallies above.
if (conns_ratio > = 2 * basis_conns_ratio) {
    // Network connectivity is more complex, so calculations of
relationships between objects will consume more resources (memory).
    // Revise our threshold to account for this.
    max_per_zone = .75 * max_per_zone;
} else if (conns_ratio < .5 * basis_conns_ratio) {
    max_per_zone = 1.25 * max_per_zone;
}
- Find the ratio of interfaces to devices or nodes, iFs_to_devices_ratio,
based on tallies above.
// If it is high, it means that more resources will be required to represent
the interface objects and relationships associated with nodes.
if (iFs_to_devices_ratio > = basis_iFs_to_devices_ratio) {
    max_per_zone = .75 * max_per_zone;
} else if (iFs_to_devices_ratio < basis_iFs_to_devices_ratio) {
    max_per_zone = 1.25 * max_per_zone;
}
// Now we have a max_per_zone threshold, which is stated in units of
nodes, that accounts for the resources of the system on which it is
deployed as well as various aspects of the network which it is deployed to
manage, and known relationships between characteristics and resource
usage.
// Now apply this threshold value to assist in the configuration of zones in
the network. Since we know that the system should not handle more than
max_per_zone nodes per pass, we can limit our zone sizes to this
threshold to allow for scalability and prevent system resource exhaustion.
- Output max_per_zone value to a database (or file) so that subsequent
zone configuration can check against it and provide feedback.
// Note that the above algorithm can be applied to analyzing the network
in one pass, but can also be applied at a more granular level, for example
by looking at this information for each subnet.
```

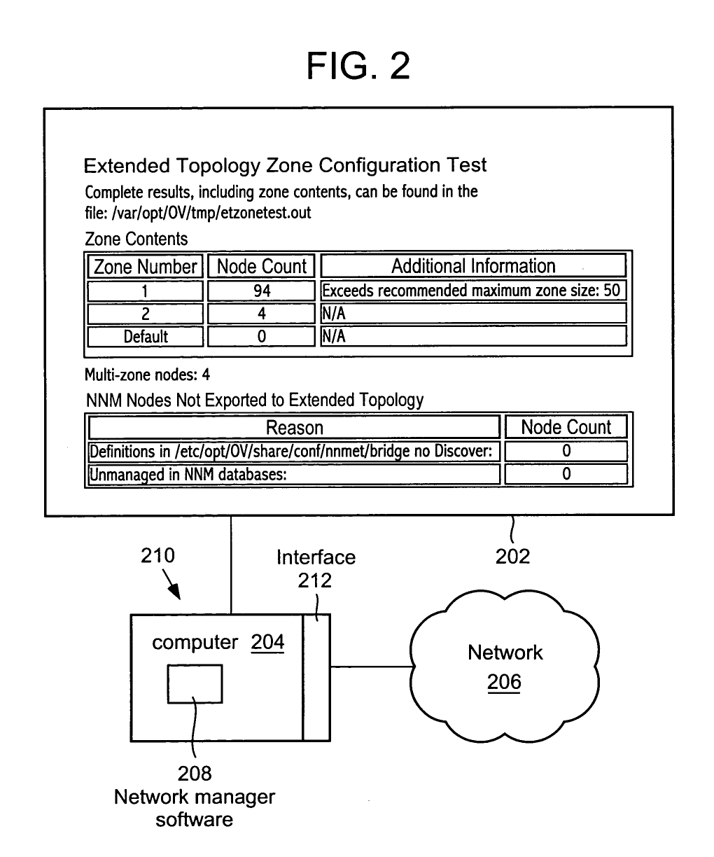

FIG. 2 shows a block diagram of a system for determining a network scalability threshold of a network manager 210 with respect to a network 206. The network manager 210 is capable of performing the functions described herein, and can be formed by a means for gathering information about the network, for gathering information about the network manager 210 itself, and for determining a maximum size threshold of a zone in the network based on the gathered network information and the gathered network manager information, for example by network manager software 208 stored in a memory of the computer system 204 and running on one or more microprocessors of the computer system 204. The network manager 210 can include an interface 212 connecting the network manager 210 to a network 206 that the network manager 210 is discovering, monitoring and/or managing. The gathering of information about the network, the gathering of information about the network manager (for example the amount of available memory of the computer system 204 and any other characteristics of the computer system 204 and the network manager software 208 that affect the maximum size threshold of a network zone that the network manager 210 can handle) can be implemented via a single software module or different software modules running on the computer system 204, by a single microprocessor or multiple microprocessors within the computer system 204. Alternatively, the means for processing and determining, or the functions of the means for processing and determining, can be implemented or performed using resources of the network, or using software and hardware resources operating independently of the network and the network manager, in a central or distributed fashion or configuration, and can provide advisory information to the network manager and/or control or direct the network manager. For example, the means for processing and determining can alert the network manager that a zone has a size exceeding the maximum size threshold, and/or can direct the network manager not to discover, manage or process a zone having a size exceeding the maximum size threshold. For example, the means for gathering and determining can be implemented within or in conjunction with Hewlett Packard's OpenView and Network Node Manager (NNM) products, including NNM Extended Topology (ET). For example, the network manager 210 can use NNM Discovery and/or NNM ET to obtain information about the network 206, for example topology, number of nodes, number of interfaces, connection densities, and so forth. NNM ET can be used to provide additional detail, for example more Layer 2 data, details regarding connections between nodes within the network 206, protocols, switches, and so forth.

The network manager 210 or computer system 204 can drive a display 202, for example to show a status or activity of the network manager 210 including scalability calculations or results, discovered network information, and so forth. For example, the exemplary screen shown in the display 202 can result when a user has configured zones and pressed a button to analyze the zones. The screen in FIG. 2 shows for example that Zone 1 has a node count of 94, which exceeds a maximum zone size calculated by the network manager 210 to be 50 nodes.

Exemplary embodiments allow a network manager (for example, a network manager formed by network management software running on a computer system) to automatically scale its activities when discovering and managing an environment such as a network so that the network manager does not overstretch or exhaust its resources. Consequently, exemplary embodiments can be robust and fault-tolerant, use resources efficiently, and eliminate the need for a user to guess about scalability limitations of the network manager when applying it to a system or network. Since exemplary embodiments allow the network manager to adapt to the system it is deployed on, large networks can be easily managed with smaller systems while optimizing performance of the network manager. Performance can be optimized, for example, through the scaling process reducing an amount of time necessary to discover the network and through reducing a configuration complexity of the network manager.

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth).

Those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method of determining a network management scalability threshold of a network manager with respect to a network, comprising:
gathering information about the network;
gathering information about the network manager; and
determining a maximum size threshold of a zone in the network based on the gathered network information and the gathered network manager information.

2. The method of claim 1, wherein:
the information about the network manager includes an amount of memory available to the network manager; and
the determining includes assigning a value to the maximum size threshold of a zone in the network based on the amount of memory available to the network manager.

3. The method of claim 2, wherein:
the information about the network includes a number of each type of node in the network, and a ratio of switches to other types of nodes in the network; and
the determining includes decreasing the maximum size threshold of a zone in the network if the ratio of switches to other types of nodes in the network exceeds a first threshold, and increasing the maximum size threshold of a zone in the network if the ratio of switches to other types of nodes in the network is below a second threshold.

4. The method of claim 3, wherein:
the information about the network includes a total number of connections between each switch in the network and other nodes in the network, and a ratio of a) the total number of connections to b) a number of nodes in the network; and
the determining includes decreasing the maximum size threshold of a zone in the network if the ratio of the total number of connections to nodes exceeds a third threshold, and increasing the maximum size threshold of a zone in the network if the ratio of the total number of connections to the number of nodes in the network is below a fourth threshold.

5. The method of claim 4, wherein the number of connections is a number of connections between the switches in the network and other nodes in the network.

6. The method of claim 4, wherein:
the information about the network includes a number of interfaces in the network, and a ratio of a) interfaces in the network to b) nodes in the network; and
the determining includes decreasing the maximum size threshold of a zone in the network if the ratio of interfaces to nodes equals or exceeds a fifth threshold, and increasing the maximum size threshold of a zone in the network if the ratio of interfaces to nodes in the network is below a sixth threshold.

7. The method of claim 6, wherein the fifth and sixth thresholds are the same, the first threshold is greater than the second threshold, and the third threshold is greater than the fourth threshold.

8. The method of claim 1, wherein the network is a zone candidate or subset of a larger network and includes specific nodes.

9. The method of claim 1, comprising preventing the network manager from discovering or managing a zone of the network having a size exceeding the determined maximum size threshold.

10. A system for determining a network management scalability threshold of a network manager with respect to a network, comprising:
means for gathering information about the network, gathering information about the network manager, and determining a maximum size threshold of a zone in the network based on the gathered network information and the gathered network manager information; and
means for connecting the network manager to the network.

11. The system of claim 10, wherein:
the information about the network manager includes an amount of memory available to the network manager; and
the means for gathering and determining assigns a value to the maximum size threshold of a zone in the network based on the amount of memory available to the network manager.

12. The system of claim 11, wherein:
the information about the network includes a number of each type of node in the network, and a ratio of switches to other types of nodes in the network; and
the means for gathering and determining decreases the maximum size threshold of a zone in the network if the ratio of switches to other types of nodes in the network exceeds a first threshold, and increases the maximum size threshold of a zone in the network if the ratio of switches to other types of nodes in the network is below a second threshold.

13. The system of claim 12, wherein:
the information about the network includes a total number of connections between each switch in the network and other nodes in the network, and a ratio of a) the total number of connections to b) a number of nodes in the network; and
the means for gathering and determining decreases the maximum size threshold of a zone in the network if the ratio of the total number of connections to nodes exceeds a third threshold, and increases the maximum size threshold of a zone in the network if the ratio of the total number of connections to the number of nodes in the network is below a fourth threshold.

14. The system of claim 13, wherein the number of connections is a number of connections between the switches in the network and other nodes in the network.

15. The system of claim 13, wherein:
the information about the network includes a number of interfaces in the network, and a ratio of a) interfaces in the network to b) nodes in the network; and
the means for gathering and determining decreases the maximum size threshold of a zone in the network if the ratio of interfaces to nodes equals or exceeds a fifth threshold, and increases the maximum size threshold of a zone in the network if the ratio of interfaces to nodes in the network is below a sixth threshold.

16. The system of claim 15, wherein the fifth and sixth thresholds are the same, the first threshold is greater than the second threshold, and the third threshold is greater than the fourth threshold.

17. The system of claim 10, wherein the network is a zone candidate or subset of a larger network and includes specific nodes.

18. The system of claim 10, wherein the means for gathering and determining prevents the network manager from discovering or managing a zone of the network having a size exceeding the determined maximum size threshold.

19. A machine readable medium comprising a computer program for causing a computer to perform:
gathering information about a network;
gathering information about a network manager arranged to monitor the network; and
determining a maximum size threshold of a zone in the network based on the gathered network information and the gathered network manager software program information.

20. The medium of claim 19, wherein:
the information about the network manager includes an amount of memory available to the network manager; and
the determining includes assigning a value to the maximum size threshold of a zone in the network based on the amount of memory available to the network manager.

21. The medium of claim 20, wherein:
the information about the network includes a number of each type of node in the network, and a ratio of switches to other types of nodes in the network; and
the determining includes decreasing the maximum size threshold of a zone in the network if the ratio of switches to other types of nodes in the network exceeds a first threshold, and increasing the maximum size threshold of a zone in the network if the ratio of switches to other types of nodes in the network is below a second threshold.

22. The medium of claim 21, wherein:
the information about the network includes a total number of connections between each switch in the network and other nodes in the network, and a ratio of a) the total number of connections to b) a number of nodes in the network; and
the determining includes decreasing the maximum size threshold of a zone in the network if the ratio of the total number of connections to nodes exceeds a third threshold, and increasing the maximum size threshold of a zone in the network if the ratio of the total number of connections to the number of nodes in the network is below a fourth threshold.

23. The medium of claim 22, wherein the number of connections is a number of connections between the switches in the network and other nodes in the network.

24. The medium of claim 22, wherein:
the information about the network includes a number of interfaces in the network, and a ratio of a) interfaces in the network to b) nodes in the network; and
the determining includes decreasing the maximum size threshold of a zone in the network if the ratio of interfaces to nodes equals or exceeds a fifth threshold, and increasing the maximum size threshold of a zone in the network if the ratio of interfaces to nodes in the network is below a sixth threshold.

25. The medium of claim 24, wherein the fifth and sixth thresholds are the same, the first threshold is greater than the second threshold, and the third threshold is greater than the fourth threshold.

26. The medium of claim 19, wherein the network is a zone candidate or subset of a larger network and includes specific nodes.

27. The medium of claim 19, comprising a computer program for causing a computer to perform:
preventing the network manager from discovering or managing a zone of the network having a size exceeding the determined maximum size threshold.
